(19) United States
(12) Patent Application Publication
(10) Pub. No.: US 2003/0025726 A1
(43) Pub. Date: Feb. 6, 2003

(54) Original video creating system and recording medium thereof

(76) Inventor: Eiji Yamamoto, Osaka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/193,204

(22) Filed: Jul. 12, 2002

(30) Foreign Application Priority Data
Jul. 17, 2001 (JP) 2001-216535

(51) Int. Cl. H04N 5/262; G09G 5/00

(52) U.S. Cl. 345/723; 345/716; 348/239

(57) ABSTRACT

Within a housing 33, a display unit 31b to display a screen and so forth by which a user selects a video stream that the user desires, a cash thrown-in slot 31d, a microphone 31e that captures voice of the user, a keyboard 31f that acquires the name and so forth of the user, a scanner 32 that captures a picture of the face and clothes of the user, and a pickup outlet 31h that ejects a CD on which original video is recorded, and so forth are provided. Based on control and authoring processing by a computer device set up within a base unit 31a, the picture and the voice of the user captured by the scanner 32, the microphone 31e and so forth, are integrated into a predetermined scene in the video stream of a movie and so forth held in advance, are recorded on a CD, and the CD is ejected to a pick up outlet 31h.

### BACKGROUND OF THE INVENTION

1. Field of the Invention

The present invention relates to an original video creating system that creates a video with originality in which a user appears, and especially to a method and a device for creating an original video, recording the original video in a recording medium in a short time and on the spot, and providing the original video to the users, and what is created (including the original video and the recording medium in which the original video is recorded).

2. Description of the Prior Art

There is a growing trend toward originality by self assertion and so forth and entertainment by self participation and so forth. As one of arts that meet such a trend, there is a picture printing device disclosed in the Japanese Laid-Open Patent Application No. 7-298123.

The conventional picture printing device disclosed in this gazette comprises a video camera that receives a picture of a photographed person and creates a first picture data, a memorizing unit for memorizing a background as a second picture data, a control unit for combining the first and the second pictures into a third picture, and a printer that prints a picture indicated by the third picture data on recording paper.

By this kind of a picture printing device, it is possible to record easily on recording paper a still image full of originality and entertainment, in which you are centered against the background.

But the conventional picture printing device only prints out the still image that combines you and the background on the recording paper. As a result, there is a problem that the still image lacks motion and story and becomes boring soon.

To resolve this problem, it is thinkable to transform a part of background and so forth of a single still image a little bit by techniques of CG (Computer Graphics) and make the still image into a video stream comprising plural segments and frames. But the editing of pictures like this takes a technician who has expertise of CG and time to process the pictures.

If a video in which you appear in scenes of video streams with a story like a movie and so forth can be created easily and left as a record, you will have deep emotion and excitement, which is different from a still image and a facial portrait and enjoy them for a long time.

### SUMMARY OF THE INVENTION

In view of the foregoing, it is the object of this invention to provide the original video creating system that creates a video with a striking originality easily, without a special technician taking the trouble to process, records the video and stores it for a long time.

The means to solve the problem

To achieve the above-mentioned object, an original video creating system according to the present invention comprises: a video stream memorizing unit operable to memorize video stream in advance; a picture capturing unit operable to capture a picture of a photographic subject; a picture combining unit operable to combine the video stream memorized in the video stream memorizing unit and the picture of the photographic subject captured by the picture capturing unit; and a recording unit operable to record the video streams combined by the picture combining unit on a recording medium.

In other words, a series of processing that integrates a picture which is specific to a user (a photographic subject) into a video stream prepared in advance, and record the video stream on a recording medium, is automated.

To be more specific, for example, within a housing like a private room, a display unit operable to display a screen and so forth by which a user selects a video stream that the user desires, a cash thrown-in slot, a microphone that captures voice of the user, a keyboard that acquires the name and so forth of the user, a scanner that captures a picture of the face and clothes of the user, and a pickup outlet that ejects a CD on which original video is recorded, and so forth are provided. Based on control and authoring processing by a computer device set up within a base unit, the picture and the voice of the user captured by the scanner, the microphone and so forth, are integrated into a predetermined scene in the video stream of a movie and so forth held in advance, are recorded on a CD, and the CD is ejected to a pick up outlet.

Incidentally, concerning output forms of an original video, it is not limited to record on a CD by a CD drive device attached to the housing. It is acceptable to record on the recording medium of a network server device (a memory like a hard disk) and the recording medium of multimedia devices like a TV, a video cassette recorder, a personal computer, a game console, a cellular phone, and so forth by distributing an original video through a network like the Internet using a transmission path of cable or wireless. Alternatively, it is acceptable that a server device on the network stores original videos, and that the multimedia devices gain access to and retrieve the stored vide data according to need. Furthermore, it is acceptable to distribute the original video by combining a distribution form that comprises storage in such server device and access from a terminal device, and a distribution form that is a recording on the recording medium by the above-mentioned server device.

Here, concerning methods of combining pictures, it is acceptable to combine the pictures by integrating a picture of the photographic subject into at least one scene of the picture in the video stream and adding the picture of the photographic subject at the head or at the tail of the video stream.

Then, the video stream memorizing unit operable to memorize the different and plural video streams, and it is acceptable to have an operator select a video stream he/she desires. Incidentally, it is acceptable that the photographic subject and the operator are the same person and that the photographic subject is a different person or a different animal from the operator.

Additionally, it is acceptable that each video stream corresponds to the information that identifies how to integrate a picture of the photographic subject. To be more specific, each video stream corresponds to a scene in the video stream that is the subject to be integrated, a picture to be integrated, and a template of voice.

Then, it is acceptable to paste a picture of the operator's face and clothes to the picture template, to insert a voice captured from the operator as-is as a line into a voice of the video stream, and to adopt the voice template whose tone is closest to the voice of the operator. By doing this, like a character in a role-playing, the operator fits in as a part of a story by delivering his/her specified lines for each scene, and a natural video completes by combining the operator into the video.

Additionally, it is acceptable that the original video creating system further includes a wrapping unit operable to wrap a recording medium recorded by the recording unit. Then the wrapping paper acquires value as a commemorative by printing the name of the operator, the date when the recording medium is created, and so forth.

Furthermore, it is acceptable that the present invention is an original contents creating system comprising a contents distribution center and an original contents creating system connected through a transmission path, wherein the contents distribution center includes: a contents memorizing unit operable to memorize contents including a voice, a still image, and a video stream; and a transmission unit operable to transmit the contents memorized in the contents memorizing unit to the original contents creating device, and the original contents creating device includes: a contents holding unit operable to receive and hold the contents transmitted by the contents distribution center; a voice and picture capturing unit operable to capture at least one of a voice and a pictures of an operator; a contents integration unit operable to integrate at least one of the voice and picture into the contents held by the contents holding unit; a recording unit operable to record the contents integrated by the contents integration unit on the recording medium; and an ejection unit operable to present and provide to the operator the recording medium recorded by the recording unit.

In other words, it is acceptable to set up plural original contents creating devices at plural spots in theme parks or throughout the nation, like vending machines connected through a communication path, to distribute the latest contents to the original contents creating devices from the distribution center, and to centralize the charging process.

Furthermore, it is possible that the present invention is realized as a program to have a general-purpose computer execute above-mentioned characteristic processing and control.

### BRIEF DESCRIPTION OF THE DRAWINGS

These and other objects, advantages and features of the invention will become apparent from the following description thereof taken in conjunction with the accompanying drawings which illustrate a specific embodiment of the invention. In the drawings:

FIG. 1 is a diagram that shows an overall structure of an original video creating system 1 according to the present embodiment.

FIG. 2 is a flow chart that shows video contents distribution processing executed by a video contents distribution device 2 shown in FIG. 1.

FIG. 3 is an outline drawing of original video creating devices 3a, 3b to 3n.

FIG. 4 is a function block diagram of the device.

FIG. 5 is a flow chart that shows details of the video contents reception processing executed by a reception unit 301a of the device.

FIG. 6 is a diagram that shows a data example of a video contents information table 302a of the device.

FIG. 7 is a flow chart that shows original video creation processing by the device.

FIG. 8A is a diagram that shows a sample of screen display at a display unit 31b.

FIG. 8B is also a diagram that shows a sample of screen display at the display unit 31b.

FIG. 9 is a diagram that shows an appearance of combining processing of the video contents by an authoring unit 308 of the device.

### DESCRIPTION OF THE PREFERRED EMBODIMENT(S)

The present embodiment of the present invention will be explained below with reference to the figures.

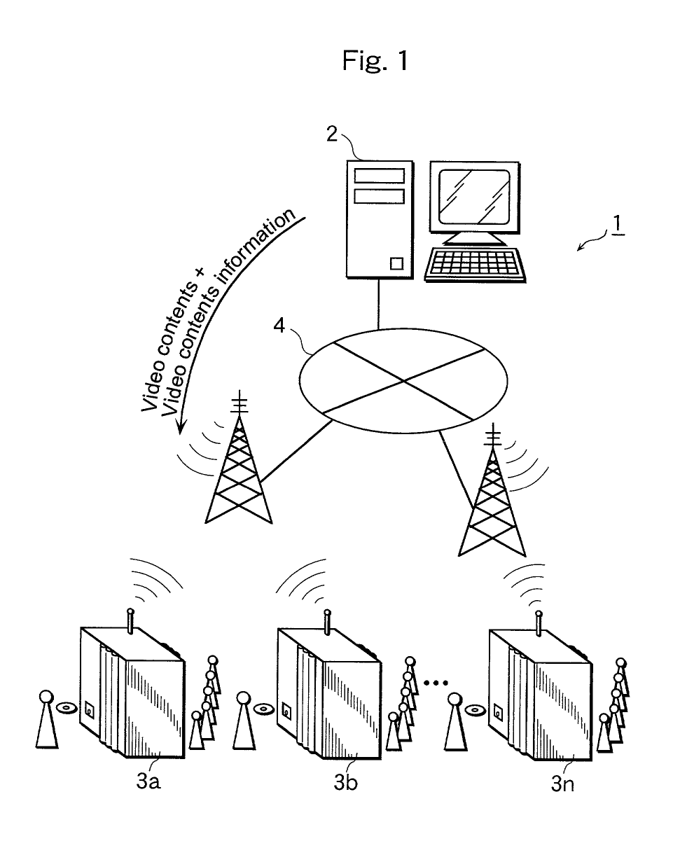

FIG. 1 is diagram that shows an overall structure of an original video creating system 1. This original video creating system 1 is a system that combines prerecorded video contents with stories and voices (photodramas, animation movies, musical movies, musical video, TV dramas, TV games, and other video) and pictures (participant's pictures) obtained by recording participants (including animals and so forth) that desire to participate as characters in these video contents, record original images obtained by this combination on the recording medium (CD (Compact Disk) according to the present embodiment), sell and provide the recorded CDs to the participants. The system comprises two kinds of devices 2 and 3 connected by a communication network 4 such as Internet; namely, the video contents distribution device 2 and plural original video creating devices 3a, 3b to 3n.

The video contents distribution device 2 is a computer device and so forth that store a plurality of the video contents provided by this original video creating system 1 in a compressed format, such as MPEG. And it is a distribution server that selects an original video creating device as a distribution object from the original video creating devices 3a, 3b to 3n when the video contents distribution device 2 distributes any of the stored video contents, and distributes the video contents together with material images information such as the title of the video contents to the selected original video creating device.

The original video creating devices 3a, 3b to 3n are located in theme parks, amusement centers and so forth. At the located place, they record a participant's pictures with voice, combine the recorded participant's pictures with the voice together with the video contents with voice distributed from the video contents distribution device 2, record the original video obtained by the combination on CDs and sell the CDs with charge. Alternatively, the original video creating device distributes original video to the recording medium (memory) of various devices and equipments connected to the original images creating device by network transmitting methods like Internet and sells the original video. So to speak, the original video creating device is a vending machine of original CDs, to be more specific, it comprises a computer device and so forth in which the following software programs are preinstalled: a software program that receives and stores the video contents from the video contents distribution device 2; and another software program that charges, acquires participant's pictures, combines the video and the participant's pictures, record the combined original video on CDs, and distributes the CDs by network.

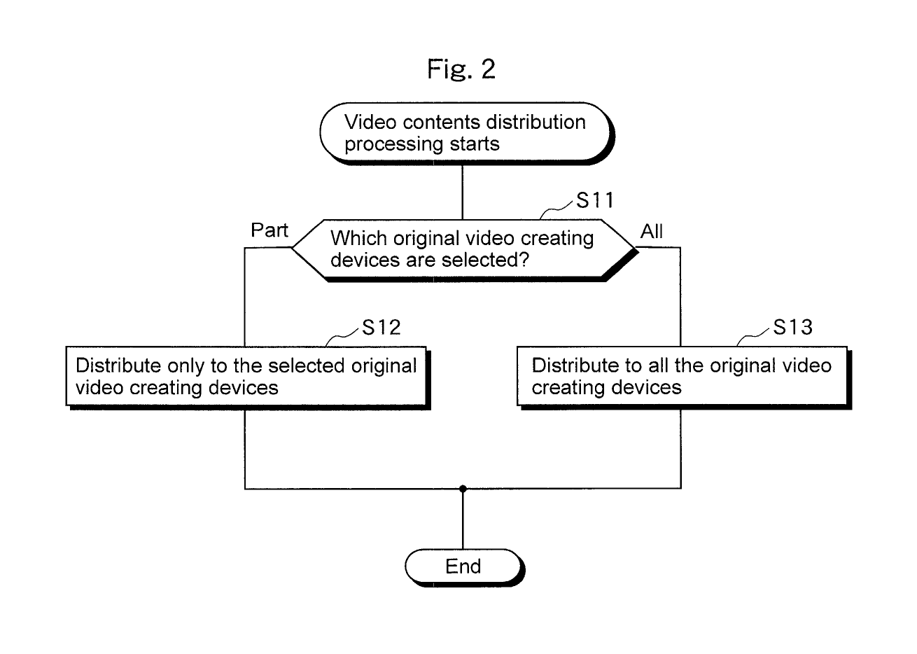

FIG. 2 is a flow chart that shows the video contents distribution processing executed by the video contents distribution device 2 shown in FIG. 1. Incidentally, this video contents distribution processing is executed at the predetermined time such as before the theme parks and so forth are open or after they are closed.

When a new title's video contents is registered, the video contents distribution device 2, for example, judges to select the original video creating devices 3a, 3b to 3n to which the new title's video contents should be distributed (S11). This judgment is done, for example, to determine suitability of the original video creating devices 3a, 3b to 3n, by comparing their characteristics (genres in which past video contents is successful, the age bracket and the tastes of the participants who gather at the located place) and the attributes such as the genre of the video contents that is distributed (major division such as foreign movies and Japanese movies, or minor division such as photodramas, animation movies and musical movies), or is done by the intention of the original video creating device.

When the original video creating devices selected by such the judgment are a part of the system 1, the video contents distribution device 2 distributes the video contents and the video contents information only to the part of original video creating devices (S12).

In contrast to this, as the result of the judgment, the selected original video creating devices are the whole of the system 1, the video contents distribution 2 distributes the video contents and the video contents information to all the original video creating devices 3a, 3b to 3n (S 13).

Accordingly, however large the number of the original video creating devices 3a, 3b to 3n is, and how far the located places of the original video creating devices 3a, 3b to 3n are, from the only one place of the video contents distribution device 2, the original video and the original video information can be sent only to the plural original video creating devices 3a, 3b to 3n that have the characteristics conforming to the attributes of the video contents without complicated trouble and in a shot time.

Incidentally, according to the present embodiment, when the new video contents are registered, original video creating devices are selected as the destinations of the distribution. It is acceptable to select the original video creating devices as the destination of the transmission when the video contents distribution device 2 manages use patterns and so forth of the original video that each original video creation device 3a, 3b to 3n holds by referring to the use patterns. In this case, instead of the video contents that each original video creating devices 3a, 3b to 3n holds and do not sell well, it is recommendable to distribute the video contents whose attributes are most appropriate for the characteristics of the original video creating device from the video contents at hand. Further, it is desirable that the video contents of each original video creating device can be deleted.

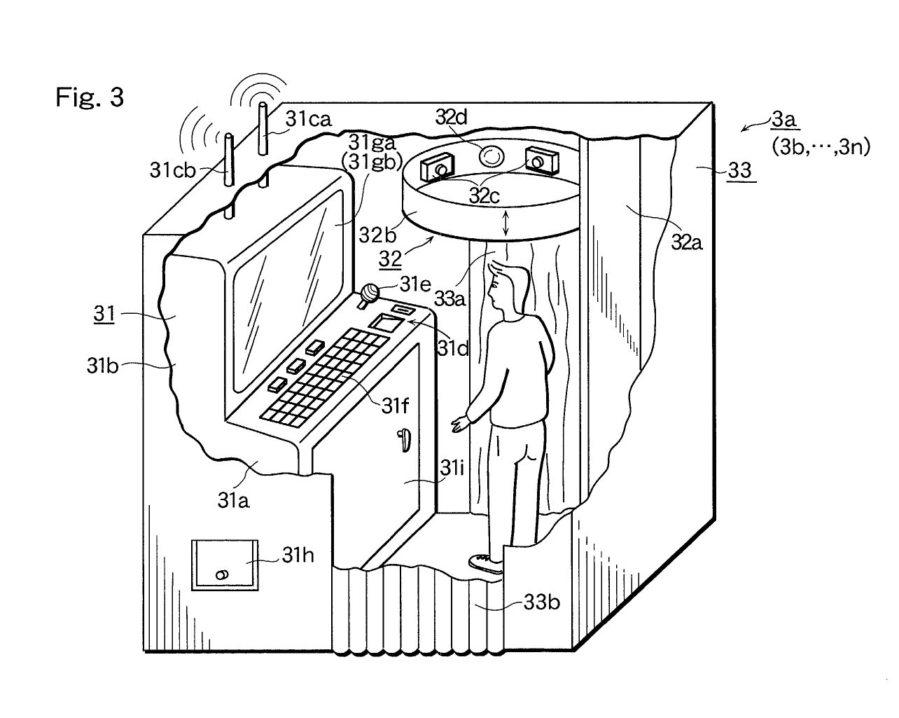

FIG. 3 is an outline drawing of the original video creating devices 3a, 3b to 3n. The original video creating devices 3a, 3b to 3n largely comprises a main unit 31, which forms the main part of the original video creating devices 3a, 3b to 3n, a scanner 32 that is placed in front of the main unit 31 and captures participant's pictures, and a housing 33 that covers the main unit 31 and the scanner 32.

The housing 33 is formed like a single room by a frame that is not indicated. To the both sides of the housing 33, for example, curtains 33a, 33b are attached. Then a participant opens a curtain 33a, enters the housing 33, executes predetermined operations at the main unit 31, records his/her pictures with a scanner 32, and after that, opens another curtain 32b and goes out of the housing 33. As a result, changing of the participants is done one-way and smoothly. Incidentally, when voice is captured by a microphone, it is acceptable to use a sealed door to shut out outside noises.

The main unit 31, which is operating panels and so forth to communicate with the participant who enters the housing 33, largely comprises a base unit 31a and a display unit 31b set up on the base unit 31a.

On top of the display unit 3b, an antenna 31ca that receives the video contents and the video contents information distributed by the video contents distribution device 2, and an antenna 31cb that distributes created video, are attached to the housing 33 with parts of the antennas sticking out. (Incidentally, it is possible to make these antennas 31ca and 31cb into a single and common antenna).

Furthermore, in the front of the display unit 31b, an LCD 31ga and a touch panel 31 gb are set up: the LCD 31ga displays the titles and so forth of plural video contents; the touch panel 31gb is attached to a surface of LCD 31ga integrally and the video contents displayed on LCD 31ga are selected by the touch panel 31gb.

On the base unit 31a, a cash thrown-in slot 31d into which coins and bills are thrown in, a microphone 31e that captures voice and a keyboard 31f by which letters and so forth are input, are set up. At the side of the exit curtain 33b of the base unit 31a, a pick up outlet 31h through which CDs that record the original video are picked up, is set up.

Incidentally, in the base unit 31a, a door that can be open and close is set up. Inside this door 31i, in addition to a computer, a CD supplying unit, a CD recording unit and a wrapping unit to wrap CDs with wrapping paper, which will be described later, are set up.

Inside the door 31i, also, CDs and wrapping paper are in stock in advance.

A scanner 32 is a 3-D picture acquiring device that acquires pictures of a face and a body type of a participant who stands still inside the housing 33, and comprises a column 32a, a ring shaped scanning unit 32b that moves up and down along the column 32a, plural electronic cameras 32c that are placed at a predetermined distance inside the scanning unit 32b, and a panel light 32d.

The scanning unit 32b is placed near the ceiling as the initial place. When it captures pictures of a participant's face and clothes, the panel light 32d comes on, the scanning unit 32b moves down gradually from the ceiling, and pictures are taken required times. By doing this, the head, the upper-body and whole-body of a participant photographed from surrounding area, pictures in predetermined range are captured. When the pictures in the predetermined range are captured, the scanning unit 32b stops moving down, after it moves up to the original place, the panel light 32d goes out.

Incidentally, according to the present embodiment, plural electronic cameras 32c photograph the participant from plural directions at the same time, but it is acceptable that each electronic camera photographs the participant at different timings. It is also acceptable to photograph the participant from the front and the side by two electronic cameras or so at the same time or separately. Furthermore, it is possible to photograph the participant by one electronic camera from the all directions by rotating the scanning unit 32b itself.

It is also acceptable to use plural video cameras, a 3-D scanner using ultrasonic reflection and so forth instead of or adding to the electronic camera 32c. It is possible to create a 3-D pictures of the participant by combining 3-D shape data (outline date) of the participant captured by a 3-D scanner and 2-D image data (pictures data) captured at the same time by electronic cameras or a video picture taking device (by pasting picture data to the surface of a 3-D object identified by outline data and so forth). It is also acceptable to identify the color of shot pictures by program processing and to color the surface of a 3-D object identified by shape data. Alternatively, it is possible to identify the body type of the participant who appears in the video contents through program processing by inputting the weight and the height of the participant at the stage where the age and the gender of the participant are input.

Furthermore, it is acceptable for the participant to select the basic parts of pictures, in other words, clothes, hair styles, presence or absence of the glasses and so forth, and to process the captured pictures with what are selected. It is also acceptable to decide the clothes and so forth by the role and so forth when the participant appears in the video and to inset the participant's pictures only to the part of the face. For other things, it is acceptable to select and combine the above-mentioned methods appropriately when the body types and the outlines of the characters that appear in the video contents are decided and the pictures of the participant are captured.

By using the above-mentioned original video creating devices 3a, 3b to 3n, it is possible to comprise the main unit 31, the scanner 32 and the housing 33 integrally and compactly and to set up the original video creating devices 3a, 3b to 3n at the places such as theme parks and game centers without taking large places.

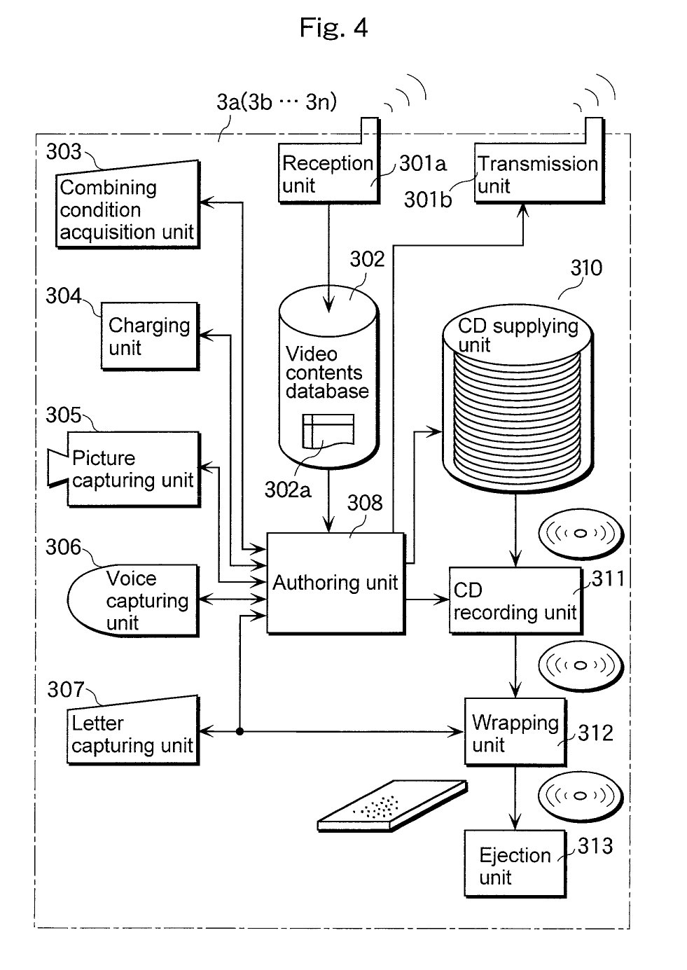

FIG. 4 is a block diagram that shows functions of the original video creating devices 3a, 3b to 3n. Each one of the original video creating devices 3a, 3b to 3n comprises a reception unit 301a, a transmission unit 301b, a video contents database 302, a combining condition acquisition unit 303, a charging unit 304, a picture capturing unit 305, a voice capturing unit 306, a letter capturing unit 307, an authoring unit 308, a CD supplying unit 310, a CD recording unit 311, a wrapping unit 312 and an ejection unit 313.

The reception unit 301a comprising an antenna 31ca, a communication program and so forth, stores the video contents and the video contents information received from the video contents distribution device 2 in the video contents database 302 and a video contents information table 302a in the database 302 respectively by executing video contents reception processing. Incidentally, the video contents database 302 is a hard disk with storage capacity that stores plural video contents, and so forth in addition to the video contents information table 302a.

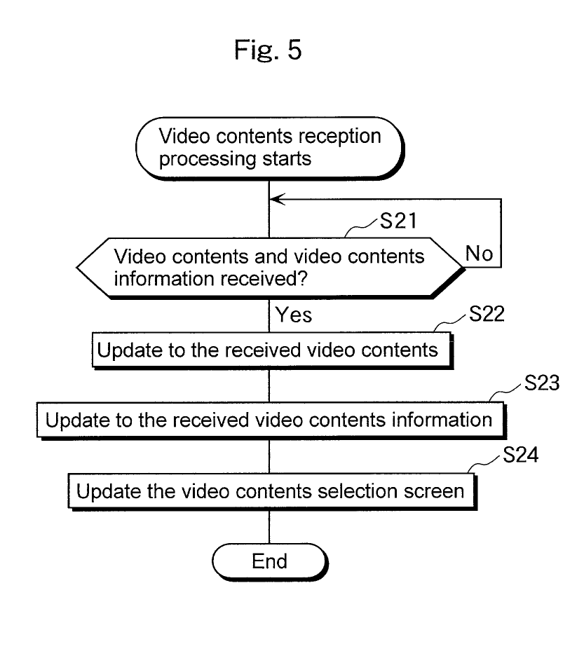

FIG. 5 is a flow chart that shows details of the video contents reception processing executed by the above-mentioned reception unit 301a. This video contents reception processing is executed every time distribution from the video contents distribution device 2 is made.

The reception unit 301a waits for the video contents distribution device 2 to distribute the video contents and the video contents information (No at S21). When the video contents and the video contents information are distributed (Yes at S21), the reception unit 301a stores the received video contents and video contents information in the video contents database 302 and updates them (S22, S23).

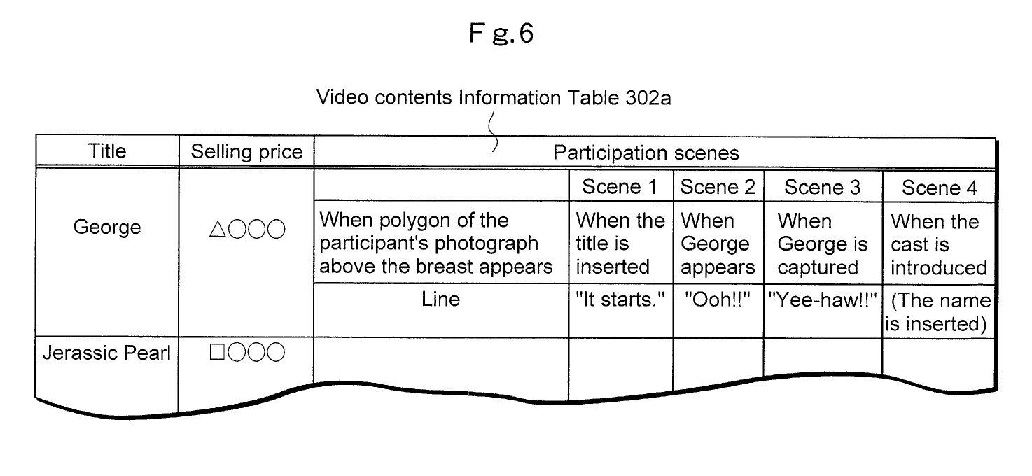

At this moment, when the video contents database 302 has no available space, the reception unit 301a overwrites the video contents with low frequency in use among plural video contents held in the video contents database 302 and stores the received video contents in the video contents database 302 (S22). Then the reception unit 301a overwrites the received video contents, in other words, the title of the received video contents, selling price of the CD that records the original video created with the video contents based on the video contents and information of participation scenes showing the time of the scenes in which the participant is combined with the video contents as a character (the video contents for combination), on the record of the video contents information of the video contents with low frequency in use in the video contents information table 302a shown in FIG. 6 and an update is made (S23).

Incidentally, the scenes of the video contents for combination, namely, the scenes in video stream that are the objects of the combination, are prepared in advance, for example, in about 4 scenes, scene 1 to scene 4, so as to satisfy entertainment of the participant and at the same time so as not to take a long time for combining the pictures. Then each scene 1 to scene 4 comprises, for example, frame pictures as the background and pictures data (polygon data) that express the character integrated into the background in three dimensions, or comprises video of the characters and an area that stores video of the participant, at the unit of GOP (Group of Pictures) based on MPEG, or incorporates a program that processes pictures captured by the scanner 32 and so forth.

Then as polygon data of the characters, postures according to age brackets and the gender, for example, plural polygon data corresponding to plural kinds of people corresponding to grown-up males, grown-up females, boys and girls are prepared in advance. A program that processes captured pictures of participant in three dimensions and pastes captured pictures according to the age, gender, weight and height.

Additionally, at each scene that needs lines, for example, the lines of a character at every scene in role-playing, “It starts”, “Ooh!!” and “Yee-haw!!” are decided in advance. For each line, plural templates which are different in the ratio α of the low, middle and high tones are prepared in advance.

When an update of the video contents and the video contents information is finished, the reception unit 301a reads out the field of title and selling price in the video contents information table 302a, updates the video contents selection display data displayed on LCD 31ga (S24), and ends the video contents reception processing.

By doing this, the participant selects the video contents sent by the video contents distribution device 2, creates original video by using the selected video contents without troubling maintenance people and so forth of the original video creating device 3a, 3b to 3n. On top of that, since the destinations distributed by the video contents distribution device 2 are selected, the video contents database 302 of the original video creating devices 3a, 3b to 3n holds invariably the latest and hot video contents and video contents information. As a result, popular contents are invariably downloaded to the original video creating devices 3a, 3b to 3n and prevent the contents from becoming out of fashion.

The combining condition acquisition unit 303, which is a processing unit to acquire directions of the participant through the touch panel 31gb, acquires the information that identifies which video contents is selected at the touch panel 31gb among plural video contents displayed on the LCD 31ga (for example, the numbers and so forth corresponding to the titles and the video contents). By this combining condition acquisition unit 303, the video contents that are objects of combination and predetermined combining conditions that correspond to the video contents (scenes where the participant appears and the line and so forth in the scenes that are stored in the video contents information table 302a) are identified.

The charging unit 304 which is a processing unit to collect the cost of original CDs produced and provided by this original video creation device, distinguishes the amount of bills and coins thrown-in to the cash thrown-in slot 31d, distinguishes whether the amount thrown-in meets the selling price determined for the selected video and calculates the change. It is possible to have a payment function by a credit card.

The letter capturing unit 307 is the above-mentioned keyboard 31f and so forth that captures information identifying the attributes of the participant (for example, the name, the age, the gender and so forth, if necessary, the height and the weight). By this letter capturing unit 307, the posture of the character used in the scenes in which the participant appears (a piece of polygon data) is identified base on the video contents information table 302a, the body type and clothes and so forth are created by the program processing, a combination mode in which how the pictures of the participant's face and clothes are pasted to and combined with the polygon data and the created body types and the name and so forth that is inserted when the cast is introduced, are decided.

Additionally, when the created video is distributed by network, addresses of destinations for distribution are inputted through the keyboard 31f of this letter capturing unit.

Moreover, the name and so forth that are printed on CDs and wrapping paper are decided by this. Furthermore, the names of the cast introduction, in subtitles and in video stream and the kind of language that can be inputted by the letter capturing unit 307 (English, Japanese and so forth) are decided by the kind of the video (Japanese movies, foreign movies, animation and so forth).

The picture capturing unit 305 comprises the scanner 32 and so forth, captures the participant's pictures shot from various angles. In this case, it is acceptable to fix a device that reads out 3-D outlines to the scanner 32, paste pictures captured by a camera to the 3-D outline and capture 3-D pictures. Additionally, only person's pictures are cut off by program processing, pictures captured from various angles are combined, and 3-D pictures are made. Incidentally, it is acceptable to combine captured pictures by authoring system processing that described later and identify 3-D pictures of the participant.

The voice capturing unit 306, which is a processing unit, captures voice of the participant and analyzes the voice, comprises an A/D converter that analyzes the frequency of the participant's voice captured by the microphone 31e and calculates the ratio α of the low, middle and high tones and FFT (fast Fourier transform) for analyzing the frequency. By this voice capturing unit 306, from the voice of template prepared in the video contents information table 302a in advance, the line of the tone that is closest to the calculated ratio α is selected. In other words, this voice capturing unit 306 is used to identify the line of voice that is closest to the participant's voice quality and tone.

Authoring unit 308 has an authoring function that combines the video contents for combination selected by the combining condition acquisition unit 303 and the participant's pictures captured by the picture capturing unit 305, the voice capturing unit 306 and the letter capturing unit 307 by each picture and voice. In addition to the authoring function, the authoring unit 308 also includes an MPEG system function that compresses video data and audio data of the video contents and the video contents for combination independently, integrates other compressed video data into one and outputs the MPEG system stream that is in synchronization with video bit stream and audio bit stream by time-stamp information. By this authoring unit 308, it is possible to create an original video data in which the participant appears as a character.

The transmission unit 301b comprises an antenna 31cb, wireless communication circuit and a communication program, and transmits the MPEG system stream outputted by the authoring unit 308 to transmission addresses inputted on the keyboard 31f.

The CD supplying unit 310 is a device that supplies writable, unused CDs to the CD recording unit 311 one by one following an instruction of the authoring unit 308. It comprises, for example, a magazine that stores plural CDs in lamination, a mechanism that moves CDs like an elevator and so forth. Incidentally, a reserve CD magazine is stored, when a CD magazine becomes empty, the CD supplying unit 310 exchanges the empty magazine with a reserve magazine and supplies CDs from the exchanged magazine.

The CD recording unit 311 comprises a CD drive device, a CD transport mechanism, a label printer and so forth. After the CD recording unit 311 records the MPEG stream data outputted by the authoring unit 308 on a CD supplied by the CD supplying unit 310, the CD recording unit 311 prints the name of the participant, the title of the video contents and so forth, and transports the CD to the wrapping unit 312 following an instruction of the authoring unit 308. Incidentally, it is acceptable to eject a label to be pasted instead of printing on the surface of the CD.

The wrapping unit 312 comprises a wrapping robot, a printer and so forth, stores wrapping material that is single piece or plural pieces of wrapping paper and so forth in lamination, prints the participant's name and the title of the video contents and so forth on the wrapping paper following an instruction from the authoring unit 308 that it needs to wrap the CD, and wraps the CD sent from the CD recording unit 311. Incidentally, it is acceptable to eject wrapping paper already printed or wrapping paper that is not printed aside from the CD or only to keep wrapping paper in the device (a method that the participants take out wrapping paper).

The ejection unit 313 comprises a transport mechanism and so forth, and ejects a CD wrapped by the wrapping unit 312 or an unwrapped CD into the pick up outlet 31h.

Alternatively, as was stated above, it is possible to have a medium on the network record the created original video and take them out. In this case, when a video editing software is installed in your personal computer, it is possible to preview the created original video later, edit and process it and rerecord it. Naturally, it is also possible to edit and process the created original video on the CD.

For the next step, operations of original video creation processing by the original video creating device 3a, 3b to 3n comprised as was stated above are explained.

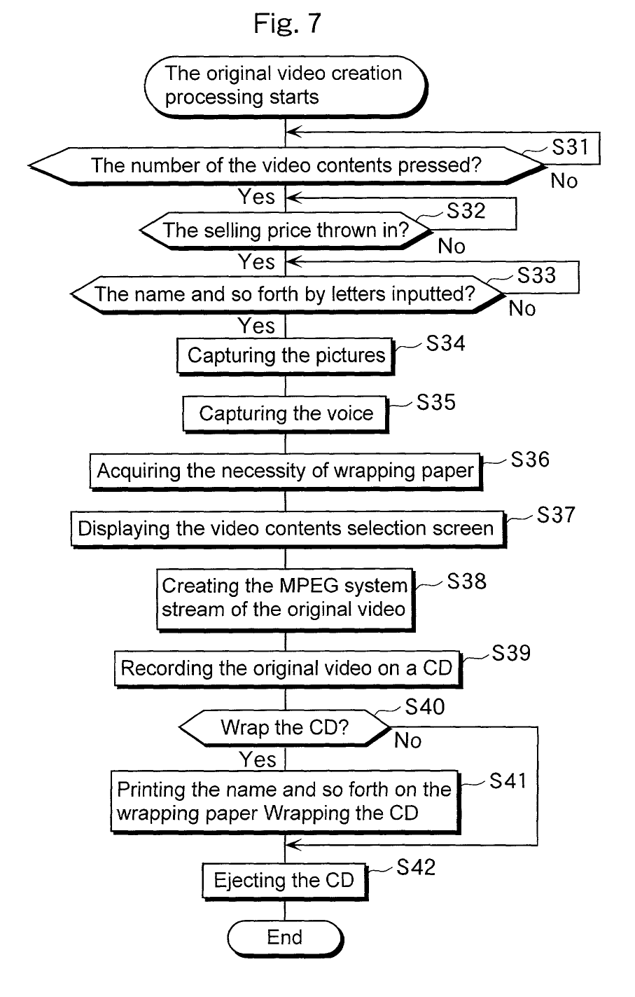

FIG. 7 is a flow chart that shows the original video creation processing executed in the original video creating unit 3a, 3b to 3n. Incidentally, in early stages of the original video creation processing, by executing Step S37 and so forth that will be described later, a select screen of the video contents corresponding to the video contents No., title and selling price is displayed on the LCD 31ga.

For a start, the combining condition acquisition unit 303 waits for the participant to press one of the original video No. (S31). When one of the original video No. (for example, The video contents 1) is pressed (Yes at S31), the combining condition acquisition unit 303 informs the authoring unit 308 of the video contents No. The authoring unit 308, which receives the information, reads out the number's selling price (the selling price of the video contents 1 Δ◯◯◯) and informs the charging unit 304 of the selling price. Incidentally, the authoring unit 308, when it reads out the selling price, reads out at the same time the video contents “George”; the video contents for combination of scenes 1˜4, when the title is inserted and the participant appears, when George appears, when George is caught and when the cast is introduced; the largest range of polygon data that is prepared there (in this example, a photograph above the breast); and in addition to the above-mentioned, the lines of scene 1˜3, “It starts”, “Ooh!!” and “Yee-haw!!”.

The charging unit 304, which was informed of the selling price, displays a screen that urges to throw in bills or coins for the selling price Δ◯◯◯ of the number's video contents “George”, for example, “Please throw in bills and coins for the selling price Δ◯◯◯ in a slot.” and waits for bills and coins to be thrown in (S32). When bills and coins for the selling price are thrown in (Yes at S32), the charging unit 304 distinguishes the thrown-in amount, confirms that the thrown-in amount meets the selling price that is determined for the selected video contents, and afterward inform the authoring unit 308 that the selling price is thrown in. Incidentally, when the thrown-in amount exceeds the selling price, the charging unit 304 calculates the change and returns the money. The informed authoring unit 308 instructs the letter capturing unit 307 to display a letter inputting screen that urges the participant to input the name and so forth by letters.

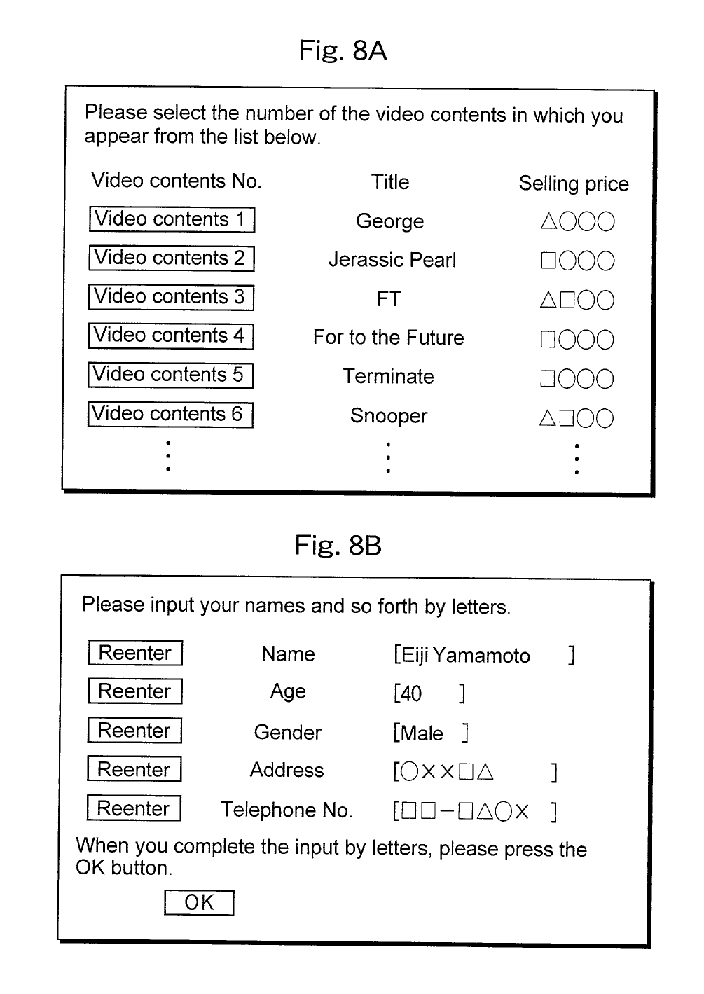

The instructed letter capturing unit 307 displays the letter inputting screen that urges the participant to input the name and so forth by letters shown in FIG. 8B and wait for the input of the name and so forth by letters (S33). The participant inputs for “name”, “age”, “gender”, “address” and “telephone number”, for example, “Eiji Yamamoto”,“40”, “Male”, “◯x x□Δ”, “□□-□Δ◯x” and so forth into text boxes and presses an “OK” button. Additionally, when it is necessary to decide the body type and so forth of the person that appears in the video contents for processing a program, the height, the weight and so forth are inputted.

Incidentally, when the participant inputs wrong names and so forth, they can reset the input of the column by pressing “Reenter” button and reenter the right letters. When the “OK” button is pressed, the letter capturing unit 307 judges the input of name and so forth by letters is finished (Yes at S33), and informs the authoring unit 308 of the name and so forth, “Eiji Yamamoto”, “40”, “Male”, “◯x x □Δ”, “□□-□Δ◯x”.

The informed authoring unit 308 memorizes the informed name and so forth in a memory, decides the polygon data (for a grown-up male) that is used in the scene where the participant appears based on the memorized age and gender, decides the body type and so forth and decides the name of the character “Eiji Yamamoto” that is used to print the label of CD and the wrapping paper. Then the authoring unit 308 informs the picture capturing unit 305 of the character and the area of the posture (a photograph above the breast) of the decided polygon data and also instructs the picture capturing unit 305 to display the pictures capturing screen that informs that the participant's pictures will be captured. Incidentally, it is acceptable that the participant can select the scene where he/she appears and his/her character.

Following the instruction of the authoring unit 308, the picture capturing unit 305 display a photographic capturing screen, for example, “As the picture taking will starts, please stand at the designated place.”, then descends the scanning unit 32b according to the informed character and the area of the posture (a photograph above the breast) of the polygon data, captures the participant's pictures in the area (the pictures of the face and the clothes) (S34), transmits the captured pictures to the authoring unit 308, and ascends the scanner 32 to the initial position. The authoring unit 308 memorizes the transmitted pictures in the memory and instructs the voice capturing unit 306 to display a voice capturing screen that informs the participant that their voice will be captured.

Following the instruction of the authoring unit 308, the voice capturing unit 306 displays the voice capturing screen, for example, “As the line will be recorded, please say something in front of the microphone.”, and afterward captures the participant's voice (S35). Then the voice capturing unit 306 converts the captured voice analog/digitally, FFT (fast Fourier transform) the analog/digitally converted voice, calculates the ratio α of the low, middle and high tones, and informs the authoring unit 308 of the calculated ratio α. The authoring unit 308 stores the ratio α of the low, middle and high tones informed by the voice capturing unit 306 in the memory, then refers to the template of the participant's line and decides the line that is closest to this ratio in the template, in other words, the line with the voice that is closest to the voice quality of the participant.

Then the authoring unit 308 displays a guidance screen that asks the necessity of wrapping paper in a display device, has the participant press a “Necessary” button or a “Not necessary” button and acquires the necessity of wrapping (S36) and stores in the memory the flag to show the necessity of wrapping that is acquired. Then the authoring unit 308 displays the guidance screen that shows, for example, “The created CD will be ejected from the outlet. Please wait outside for a while.”, and afterward instructs the combining condition acquisition unit 303 to display the screen to select the video contents shown in FIG. 8A (S37). By doing this, the combining condition acquisition unit 303 can have the next participant select the video contents.

Incidentally, the authoring unit 308 retains the following information in the memory as a database: the video contents “George” whose number is selected by the combining condition acquisition unit 303; the name “Eiji Yamamoto”, the age “40”, the gender “Male”, the address “◯x x □Δ” and the telephone number “□□-□Δ◯x ” inputted by the letter capturing unit 307; the participant's pictures captured by the picture capturing unit 305; the ratio Δ of the low, middle and high tones of the voice captured by the voice capturing unit 306. Thus the authoring unit 308 deals with additional orders later and new orders based on other video contents. In other words, the authoring unit 308 stores these data in an external memorizing device corresponding to the participants, and uploads these data to a distribution center and stores these data in the distribution center.

After the authoring unit 308 finishes the instruction to the combining condition acquisition unit 303, the authoring unit 308 first combines the video contents for combination selected by the combining condition acquisition unit 303 with the participant's pictures acquired by the picture capturing unit 305, the voice capturing unit 306 and the letter capturing unit 307, by pictures and by voice.

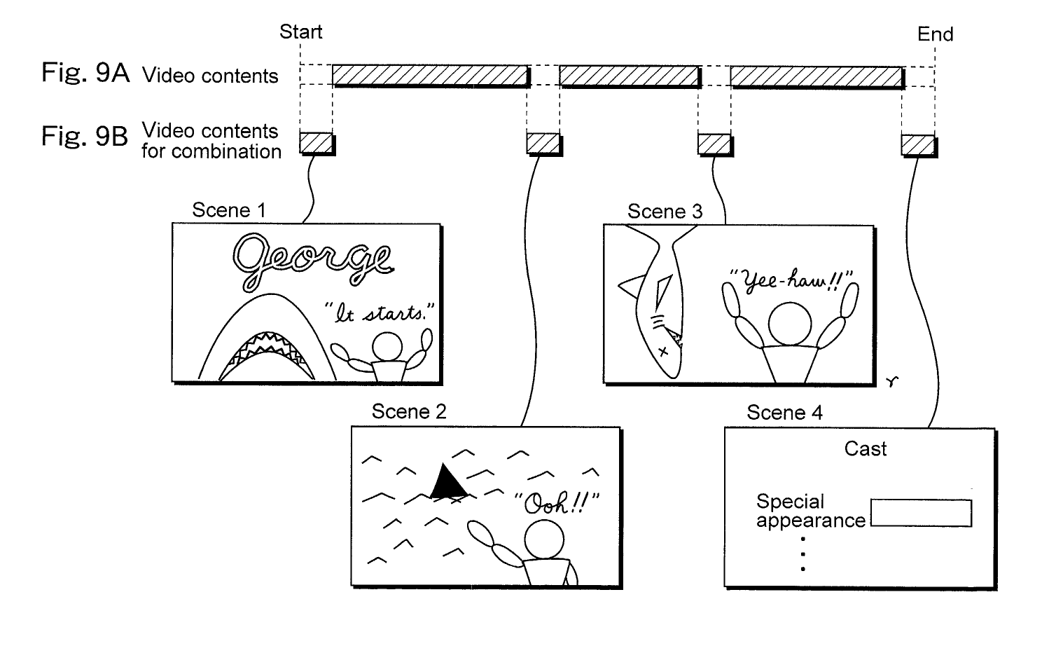

To be more specific, when a participant Eiji Yamamoto selects the video contents “George”, the authoring unit 308, with regard to the video contents for combination for the scene 1 to the scene 3, combines the polygon data shown in FIG. 9 (As the “age” of the participant is 40 and his “gender” is male, the video contents for combination integrated with the polygon data that is a posture of a grown-up male are selected) with the just captured pictures (the face, the clothes and so forth) that are texture mapped and afterward are given the third dimension by rendering into the background pictures of the scene 1 to the scene 3.

Incidentally, when the authoring unit 308 decides the body type of the participant by program processing, the authoring unit 308 automatically decides and combines the body type according to the information of the captured pictures, the height and the weight. In this case, it is acceptable that the authoring unit 308 decides the participant' basic body type by program processing, transforms basic body type by the information of the outline of the captured pictures, the height and the weight and pastes the pictures (image data) captured by the scanner 32 to the transformed pictures (shape date) and combines them. At this time, it is acceptable for the authoring unit 308 to process the captured video appropriately according to the kind of the video (color, monochrome, animation and so forth).

Additionally, with regard to the lines of the scene 1 to the scene 3, the authoring unit 308 inserts the lines “It starts.”, “Ooh!!” and “Yee-haw!!” with the voice that is closest to the ratio a of the low, middle and high tones of Eiji Yamamoto's voice from the template that is prepared in advance. Furthermore, with regard to the video contents for combination, the authoring unit 308 videorizes the participant's “name” (in this case, “Eiji Yamamoto”), and combines with rectangular parts of FIG. 9. Such combination will complete in a shot time as only four scenes are integrated.

Incidentally, as specific methods of combining pictures, besides the above-mentioned method to paste only the surface pictures such as a face and clothes to the 3-D model of the participant that is prepared in advance, it is acceptable to adopt a method to integrate 2-D pictures themselves captured by a camera and a video filming device, into frame pictures of the video contents by the unit of a photograph and combine them, a method to create a 3-D model of the participant by using the above-mentioned 3-D scanner, camera and so forth, create 2-D projective pictures of the participant seen from a certain angle by using a graphic processor and so forth and integrate the 2-D projective pictures of the participant with the video contents.

After the combination completes, the authoring unit 308 compresses video data and audio data of the video contents and the video contents for combination respectively, outputs the MPEG system stream that is in synchronization with the video bit stream and the audio bit stream by the time stamping information.

To be more specific, the authoring unit 308 reads out the video data and audio data of the video contents (FIG. 9A) and the video contents for combination (FIG. 9B) of the scene 1 to scene 4 that are already combined, in time sequence (in the order of scene1, the video contents, scene 2, the video contents, scene 3, the video contents and scene 4), makes the video data and audio data into compressed codes respectively by a video encoder and an audio encoder and creates the video bit stream and audio bit stream. Then the authoring unit 308 adds on a stream ID that identifies the kind of media, a time stamp for decoding and synchronized replay to the video bit stream and the audio bit stream respectively, and makes them into packets. Furthermore, the authoring unit 308 gathers packets of video, audio and so forth for about same amount of time and make the packets into packs, creates the MPEG system stream that multiplexes the original video in which the participant appears as a character into one bit stream (S38).

When the authoring unit 308 creates the MPEG system stream, the authoring unit 308 outputs this stream to the CD recording unit 311, while the authoring unit 308 instructs the CD supplying unit 310 to supply a CD and has the CD supplying unit 310 supply a CD to the CD recording unit 311.

The CD recording unit 311 records the MPEG stream of the original video created by the authoring unit 308 on the CD supplied by the CD supplying unit 310 (S39). Then, when the CD recording unit 311 finishes recording, the CD recording unit 311, following the printing instruction received from the authoring unit 308, label-prints the title with the name of participant, for example, of the video contents (for example, “George with a special appearance of Eiji Yamamoto”) on the surface of the CD and sends the CD out to the wrapping unit 312.

When the CD is sent out to the wrapping unit 312, the authoring unit 308 looks at the flag that indicates the necessity of wrapping and informs the wrapping unit 312 of the necessity of wrapping (S40). Incidentally, when the wrapping is necessary, the authoring unit 308 also instructs the wrapping unit 312 to print on the wrapping paper the title of the video contents with the name of the participant in it: “George with a special appearance of Eiji Yamamoto”. When the wrapping is necessary (Yes at S40), the wrapping unit 312 prints the instructed title with the name of the participant in it: “George with a special appearance of Eiji Yamamoto” on the wrapping paper, afterward wraps the CD with this wrapping paper (S41), and sends out the CD to the ejection unit 313. In contrast to this, when the wrapping is not necessary, the wrapping unit 312 sends out the CD, which was sent from the CD recording unit 311, as-is to the ejection unit 313.

The ejection unit 313 ejects a wrapped CD or an unwrapped CD sent out from the wrapping unit 312 (S42). Incidentally, it is acceptable to decide in advance whether CDs are wrapped or not without the participants deciding the necessity of the wrapping.

Additionally, as was stated above, it is possible to distribute the created original video by network. In this case, the transmission unit 301b distributes the original video combined and created by the authoring unit 308 shown in the FIG. 4 to the transmission addresses inputted through the keyboard 31f.

Thus, by the present original video creating system, the contents with striking originality that participants appear in video streams like movies and so forth as characters and speak their lines are created easily, and the participants can take possession of the original CD containing the contents in a short period of time.

Up to this point the embodiment of the present invention is explained, it is possible to make various changes without a departure from the intention of the present invention.

Especially, operation contents and methods of capturing the characters or the animals, inputted part of the voice, the necessary letters and so forth, the combined video creation and recording part to the recording medium and the wrapping part and the ejection part are changed as required. The shape of the device as a whole or the shape, operation methods, an order of the operations or placement of the individual function parts of the device are also changed as required.

Additionally, the individual functions can be omitted according to the embodiment. Furthermore, the individual devices can be implemented in separated conditions without a departure from the intentions of the present invention. For example, it is acceptable to separate the device to capture the participants' pictures and voice, the device to execute the edition of the video and voice based on the captured pictures and voice of the participants, and the device to write and wrap CDs.

Similarly, it is acceptable that the position of the CD ejection part does not integrated into the devices outside or inside of the original video creation devices 3a, 3b to 3n, and CDs are ejected at the different places from the original video creation device 3a, 3b to 3n. To be more specific, it is acceptable that the CD supplying unit 310, CD recording unit 311, the wrapping unit 312, and the ejection unit 313 are set up in the recording medium hand-delivery place located near the original video creating devices 3a, 3b to 3n, the authoring unit 308 sends the MPEG system stream to the CD recording unit 311, and the authoring unit 308 instructs CD supplying unit 310, CD recording unit 311 and CD wrapping unit 312 to hand unwrapped or wrapped CDs at this recording medium handing place. In this case, it is also desirable that CDs and equipment for wrapping can be added at any time and stored in advance inside of the device that includes the CD supplying unit 310, the CD recording unit 311 and so forth.

Additionally, it is acceptable that plural groups comprising the CD supplying unit 310, the CD recording unit 311 and the wrapping unit 312 are set up, the authoring unit 308 sends the MPEG system stream to each CD recording unit parallel and instructs each CD supplying unit 310, each CD recording unit 311 and each wrapping unit 312 parallel. In this case, the participants who form a queue before the original video creating devices 3a, 3b to 3n, and the participants who are waiting for the ejection of CDs waits for a shorter time and the annoyance of the waiting people will be reduced substantially.

Moreover, according to the present embodiment, the housing 33 has two entrance doors both sides, it is acceptable that the housing 33 has only one entrance door. Additionally, the original video creating device receives the video contents by wireless communication using the antenna 31ca, it is acceptable that the original video creating device receives and transmit the video contents, created video and so forth by cable network or telephone network.

Furthermore, according to the present embodiment, the authoring unit 308 displays the video contents selection screen shown in FIG. 8A and urges the participants to throw in the money, when the selling prices are identical, it is acceptable to display the video contents selection screen after the money is thrown in. It is also acceptable that the money is thrown in after all the operations completes. It is also easily possible to include a function of the credit card payment procedure. Additionally, according to the present embodiment, the selling price is decided by the selected video contents, it is acceptable that the selling price is decided by the character and so forth when the participants appear in the video. For example, when the participant selects the hero or the heroine who appears long time in the video, the selling price becomes high. Furthermore, it is acceptable to decide the selling price by the combination of the selected video and the selected character of the participant.

Additionally, the display of the operation procedures, the selection of the video, the writing of the necessary letters and so forth are not limited in this way, other ways are acceptable. Namely, the necessary letters of the name and so forth are inputted by a keyboard, it is acceptable that the participants press the buttons of the screen that displays the keys for ABC and that the participants fill in the display by handwriting using special instruments that are prepared like a mouse and a light-pen. Moreover, it is also acceptable that only the operation procedures are displayed and the participants operate with prepared fill-in instruments like buttons, a keyboard, a fill-in plate and so forth.

Then it is also acceptable that the participants fill in their names and necessary information when the letters are filled in, and that the necessary information is stored in the original video creating device or an external memorizing device as the customer data. Additionally, the fill-in of names by letters and so forth may be omitted if it is possible.

Moreover, it is also acceptable to receive voice input through the voice capturing unit 306 and so forth and convert the captured voice into letters instead of input by the keyboard 31f or to input by handwriting on a touch panel. In this case, to confirm the names it is desirable that the confirmation of the names on the screen are displayed and the participants can correct the names that the original video creating device reads incorrectly. In other words, the order and the screens of the operation screens are not limited to the present embodiment, it is desirable that the participants can confirm the whole contents of the input on the operation screen after the selections complete or the input of the necessary information completes.

Furthermore, it is acceptable to return to the initial state by the way of the operations. At the time the combined video streams are recorded, wrapped and ejected, the screen returns to the starting screen and the next participant can operate. In this case, the combined video streams are memorized by the original video streams creation device, in turn, recorded on the recording medium like CD and so forth, wrapped and ejected. In other words, by pipelining the individual processes of the manufacturing (the capturing the pictures, the combination processing, the record processing on CDs, the wrapping processing, the ejection processing and so forth) and by staggering and overlapping the manufacturing processes of original CDs for plural participants, it is possible to increase the number of original CDs that are produced per unit time.

Additionally, it is acceptable to adopt the line that the participants input by voice as-is instead of selecting from the template of the lines. Moreover, it is also acceptable to analyze the voice captured from the microphone 3le and generate afresh the voice of the line that is close to the quality of the captured voice by voice combination. Furthermore, it is acceptable to generate the voice of the participants, identify and adopt the close voice among the existing voice without using a microphone and by changing the voice quality of the line of the standard voice based on the nonphonetic information like the personality and the age inputted by the participant, the body type and the outline and so forth revealed by the pictures captured by the scanner 32. Alternatively, it is acceptable simply to integrate the lines selected by the participants among plural kinds of voice prepared in advance, for example the lines of famous actors or actresses, into the video contents.

Moreover, according to the present embodiment, the scenes where the participants can take part in, the posture and the lines of the polygon data that appears are predetermined corresponding to the video contents, it is acceptable that the participants select freely. Furthermore, it is acceptable that the participants select the scenes where the participants appear, the number of the scenes, the character and so forth that the participants play instead of fixing them. It is also acceptable that the participants appear in the part of the video contents replacing the people and the animals that appear originally and that the participants appear additionally in new places where the people and the animals do not exist.

Additionally, the scenes where the participants appear are not limited to a part of the video contents. When the video contents is musical video, a role playing game and so forth, it is acceptable that the participants appear in the whole of the video contents. In this case, it is acceptable that the participants appear in person as if they were singers or the heroes or the heroines of the game.

Furthermore, the number of the participants that are the objects integrated into the video contents is not limited to one, but plural participants are acceptable. In this case, it is acceptable that the number of participants is selected by the original video creating device and that the pictures and the voice are captured at the same time or one by one. Then, when musical video like a chorus or a duet are created, the pictures and the voice are captured at the same time. At this time, in the case of the voice and so forth, it is acceptable to capture all the voices sung but it is desirable to process the correction of the off-key parts by a program processing.

To generate the combined video of musical movies and so forth, it is acceptable to integrate the video of musical movies and so forth into the template of the video and the lines integrated in advance into the video contents according to the present embodiment. It is also acceptable to videotape the whole singing figure and the song by a video shooting device and so forth, record the video as-is or after connecting the video temporally with the existing video contents. In the case of the latter, instead of capturing the partial pictures of the human body according to the present embodiment, it is acceptable to capture the whole video (for example, the figure that is singing on a small stage and the singing voice) by using the video shooting device and so forth set up at a distance. The participants can select whether their partial video is combined with the video contents or the whole screen image (the screen image of one screen) is combined with the video contents.

Additionally, when the selected video contents are an animation movie “Snooper”, it is acceptable to process the captured pictures corresponding to the video in the style of an animation and so forth by devising the posture of the polygon data.

Furthermore, it is acceptable to combine the pictures and the voice captured at the same time by using plural original video creating device. For example, when a video stream in which plural participants appear in one screen image, the pictures and the voice are captured at the same time by using plural original video creating devices, the captured pictures and voice are processed into one screen image and recorded. To be more specific, each participant selects their original video creating devices. In other words, a button to create the video at the same time is prepared at the operation screen, the participants press the button, the original video creating device functions as the device to create the video, the other device that is used to create the video at the same time is decided, the captured pictures and voice are transmitted to one master device, which combines the pictures and the voice, records the combined pictures and voice on the CDs and so forth, and ejects the CDs and so forth. Incidentally, it is acceptable to fix the combination that is used to combine the captured pictures and voice, and the master device.

This processing by plural original video creating devices in a coordinated fashion is suitable for the above-mentioned production of the musical video and so forth. The voice and the pictures of the singing figures captured by the different original video creating devices are combined into the one musical screen image and video in which plural participants appear just like one screen image is generated. The combination of the pictures and the voice, recording on the CDs and the processing of the ejection and so forth in this case can be done by each original video creating device used or by one master device. Then by preparing a microphone with a code, the participant can sing and dance like a singer. Incidentally, concerning songs, like above-mentioned lines in a video stream, it is acceptable to generate singing voice without using the microphone, based on the nonphonetic information like the age, the gender, the body type and so forth and by program processing, or to identify the closest voice among the existing singing voice and combine the voice with the video. It is also acceptable to attach a voice collecting device to the microphone.

Additionally, according to the present embodiment, the scenes of the video streams, the participant's pictures and so forth are combined as the condition of uncompressed pictures, and compressed after the combination, it is acceptable to adopt the method by which compressed pictures are combined. In this case, it is acceptable to compress the pictures captured by the picture capturing unit 305, combine the compressed pictures into the video streams or replace the compressed pictures at the unit of compressed data (a picture or Group of Pictures) that can be decoded independently, and comprise the video streams stored in the video contents database 302.

Moreover, according to the present embodiment, one piece of video contents is selected by one operation of the participant and one CD is sold, it is also acceptable to select plural pieces of the video contents with one operation by the participant and to buy plural CDs of the same video contents by reconstructing the video contents selection screen. By doing this, it is possible to reuse the pictures, the voice, the letters like the name and so forth by single capturing processing of the picture capturing unit 305, the voice capturing unit 306 and the letter capturing unit 307 and to cut down the total processing time. Furthermore, the participants can distribute the CDs that they bought as memorial souvenirs and have the different kinds of original video at a time.

As explained above, in the devices and the system of the present invention, the video is integrated in the explanation, it is acceptable to send the pictures and the letters like the name and so forth and the voice of the people and the animals that appear through the communication with the devices as terminals, to process and produce the video at the side of the reception, to send back the created video through the communication and to record the created video on CDs and eject the CDs at the side of the devices. In this case as well, the recording medium for recording is stored in the devices in advance. Furthermore, it is acceptable that the devices only send the pictures, the letters like the name and so forth and the voices of the people and the animals that appear and that the creation of the video and the recording on the recording medium are done at a different place.

In other words, it is acceptable that the pictures, the voice and the letters like the name and so forth captured by a certain original video creating device are sent through communication to the video contents distribution device, which processes the video by authoring system and sends the video processed by the authoring system back to the same original video creating device or a different original video creating device, and that the original video creating device that receives the video records the video on the CDs, and processes by the whole system, sharing the roles. Alternatively, it is acceptable that an operator selects the video contents in an original video creating device, and afterward the video contents distribution device distributes the video contents to the original video creating device, which combines the voice and the pictures captured by the original video creating device and the video contents that are distributed, records the combined video on a CD, and ejects the CD, and the operator receives the CD.

In this case, each original video creating device does not need to have the video contents and only need to have a selection menu of the video contents held by the video contents distribution device, therefore it is possible to simplify the structure of the original video creating device. Furthermore, since the options for favorite video contents broaden, it is possible to receive special orders using the video contents held by the video contents distribution device and to hand out the video on the spot or a different place.

Additionally, the operation contents and the methods or the shape of the reception unit 301a can be modified appropriately, and it is acceptable to omit the reception unit 301a, and comprise the original video creation device alone.

Furthermore, it is acceptable to compile which video contents is offered to the users how many times and by which original video creating device and to leave the result in the original video creating device or an external memorizing device. In this case, it is necessary to count the number the video contents is provided at timings like the time when the operators select the video contents, the time when the original CDs are ejected at the original video creating devices and so forth, to record and compile the number in the original video creating device, the external memorizing devices and the video contents distribution device and to keep track of the number by the original video creating devices and by the video contents. By doing this, it is of help to manage the frequency of each original video creating device, the copyright fee and so forth.

Concerning the recording medium for recording, it is not limited to video tapes or recording optical disks or recording paper, it is necessary to select the best as long as it does not go out of the intention of the present invention. Namely, according to the present embodiment, CDs are used as the recording medium, but it is acceptable to be executed on other recording medium: optical disk like DVD (Digital Video Disk); MO (Magnet Optical) disk; FD (Flexible Disk); MD (Mini Disc); HD (Hard Disk); memory card like Memory Stick.

Additionally, the recording medium can be the memory of the server on the network, the multimedia devices and equipment like a TV, a personal computer, a game console, a telephone and so forth.

Furthermore, the present invention can be realized as a program in which a general-purpose computer executes the above-mentioned characteristic processing and control. Then, it is also possible to build a system with personal computers and so forth as hardware. In this case, personal computers and so forth select the video contents, send single or plural pictures, video streams and the voice to the video contents distribution device, which processes the video by authoring system, sends the video processed by authoring system back to the original personal computer or the different personal computer and so forth, and the combined video is shown and recorded on the recording medium by the personal computer.

Alternatively, the video contents distribution device distributes the selected video to personal computers and so forth or other devices, the personal computers and so forth combine the pictures and the voice captured by the personal computers and so forth, the distribution center records the combined video and hand it out to the users. At this moment, the above-mentioned program and template, which combine the captured pictures and voice, are integrated into the video contents sent by the video contents distribution device, then the operator executes the program that is sent, operates following the instructions, and generates the combined video (processes it by authoring system).

Additionally, it is acceptable to record the video into which the program and the template to create the combined video is integrated, on the recording medium like CDs and DVDs and so forth, to place the video on the market, so that creators buy the recording medium and produce the original CDs and so forth with personal computers and other devices. At this moment, to capture the pictures, it is acceptable to capture the necessary pictures by using the products for general-purpose like a digital camera, a video recording device, a scanner and so forth or a special-purpose camera for capturing pictures. It is acceptable to process the captured pictures by the distribution center or a personal computer and so forth. To process the pictures by a personal computer and so forth, it is acceptable to distribute the necessary program by the distribution center by communication network. When the CDs or the DVDs are used, it is also acceptable to integrate the program for processing into the CDs or the DVDs. Incidentally, concerning music, like the pictures, it is acceptable to distribute or deliver the program for processing. To capture the voice, it is acceptable to use microphones connected to personal computers or microphones and so forth of capturing equipment like a video recording device and so forth. Moreover, as was stated above, it is acceptable to decide automatically the voice quality based on the nonphonetic information like the age, the gender and so forth, to generate afresh the voice of the lines by the voice combination and to integrate the voice into the video contents.

The effect of the invention

As is clear by the above-mentioned explanation, it is possible to create the video in which different people and animals appear, in any place, easily, in a shot time, at a low price, to hand out the created video as videotapes, recording optical discs or recording papers, or to sell the videotapes, the recording optical disc or recording papers.

Additionally, it is possible to distribute the created video on the network, to record and edit the created video on the recording medium of the other equipment, and to use and store the created video very easily and fast.

In other words, without a special technician of CG taking the trouble to process, it is possible to generate the video with striking originality, to confirm before recording by previewing, to record on the recording medium, and to store for a long time.

It is possible to set up these original video creating devices in theme parks and make them systems where the combined video with striking realism in which the users of the devices (ordinary visitors) appear in the video where the characters of the them park appear are generated, recorded on CDs, and the users can bring the CDs back as commemoratives and souvenirs. By this, the users can keep the pleasant memory at the theme park with the original CD for ever. It goes without saying that it is possible to distribute to the recording medium on the network and to be stored.

What is claimed is:

1. An original video creating system, comprising:
a video stream memorizing unit operable to memorize video stream in advance;
a picture capturing unit operable to capture a picture of a photographic subject;
a picture combining unit operable to combine the video stream memorized in the video stream memorizing unit and the picture of the photographic subject captured by the picture capturing unit; and
a recording unit operable to record the video streams combined by the picture combining unit on a recording medium.

2. The original video creating system according to claim 1,
wherein the photographic combining unit combines the picture of the photographic subject and the picture in the video stream by integrating the picture of the photographic subject into at least one scene of the picture in the video stream.

3. The original video creating system according to claim 1,
wherein the picture combining unit combines the picture of the photographic subject and the video stream by adding the picture of the photographic subject at the head or at the tail of the video stream.

4. The original video creating system according to claim 1,
wherein the video stream memorizing unit memorizes different and plural video streams,
the original video creating system further includes a combining condition acquisition unit operable to acquire, from an operator, a combining condition that identifies which of the plural video streams are combined with the pictures of the photographic subject, and
the picture combining unit combines the pictures of the photographic subject with the video stream that the combining condition acquired by the combining condition acquisition unit identifies.

5. The original video creating system according to claim 4 further comprising:
a combining mode table memorizing unit operable to memorize a combining mode table that designates modes of the combination corresponding to the plural video streams memorized by the video stream memorizing unit, and
the picture combining unit identifies the mode of the combination corresponding to the video stream that the combining condition acquired by the combining condition acquisition unit identifies, referring to the combining mode table memorizing unit and combines the video stream and the pictures of the photographic subject in the identified mode.

6. The original video creating system according to claim 5,
wherein the mode of combination includes the information that identifies a scene of the video stream that is combined with the picture of the photographic subject, and
the picture combining unit combines the pictures of the photographic subject with the scene.

7. The original video creating system according to claim 6,
wherein the video stream includes plural template pictures which integrate into the scene, and
the picture combining unit integrates a picture of the photographic subject into the scene of the video stream using one picture selected from the plural template pictures.

8. The original video creating system according to claim 7,
wherein the picture capturing unit captures a surface picture of the photographic subject, and
the picture combining unit completes the picture of the photographic subject by pasting the surface picture captured by the picture capturing unit to the selected one template picture, and integrates the completed picture of the photographic subject into the scene.

9. The original video creating system according to claim 8 further comprising:
an operator information acquisition unit operable to acquire an operator's gender and age, and
the picture combining unit identifies the one template picture based on the acquired gender and age of the operator, completes the picture of the photographic subject by using the template picture and integrates the completed picture of the photographic subject into the scene.

10. The original video creating system according to claim 1 further includes:
a voice capturing unit operable to capture a voice that the photographic subject makes; and
a voice combining unit operable to integrate a line of the photographic subject acquired based on the voice captured by the voice capturing unit into the video stream.

11. The original video creating system according to claim 10,
wherein the voice combining unit identifies the line that is close to the voice captured by the voice capturing unit from lines of plural tones memorized in advance, and integrates the identified line into the video stream.

12. The original video creating system according to claim 1 comprising,
a unit operable to preview the combined video stream or to edit the combined video stream.

13. The original video creating system according to claim 1 further comprising,
a wrapping unit operable to wrap the recording medium recorded by the recording unit.

14. The original video creating system according to claim 13 further comprising:
a name acquisition unit operable to acquire an operator's name from the operator, and
the wrapping unit prints the name acquired by the name acquisition unit on wrapping paper and wraps the recording medium with the wrapping paper.

15. The original video creating system according to claim 1 further comprising,
an ejection unit operable to hand out the recording medium recorded by the recording unit to an operator, and
the ejection unit, the video stream memorizing unit, the picture capturing unit, the picture combining unit and the recording unit are stored in one housing box.

16. An original contents creating system comprising a contents distribution center and an original contents creating device connected through a transmission path,
wherein the original contents distribution center includes:
a contents memorizing unit operable to memorize contents including a voice, a still image and a video stream; and
a transmission unit operable to transmit the contents memorized in the contents memorizing unit to the original contents creating device, and
the original contents creating device includes:
a contents holding unit operable to receive and hold the contents transmitted by the contents distribution center;
a voice and picture capturing unit operable to capture at least one of a voice and a picture of an operator;
a contents integration unit operable to integrate at least one of the voice and the picture captured by the voice and picture capturing unit into the contents held by the contents holding unit; and
a recording unit operable to record the contents integrated by the contents integration unit on a recording medium.

17. The original contents creating system according to claim 16,
wherein the original contents creating device is connected with a device that is at another place through the transmission path by network, transmits the created video to the recording medium of the device through the transmission path, and record the created video on the recording medium.

18. A program for an original contents creating device,
wherein the original contents creating device includes a contents holding unit operable to accumulate and hold plural contents, and
the program causes a computer to function as a voice and picture capturing unit operable to capture at least one of a voice and a picture of an operator;
a contents integration unit operable to integrate at least one of the voice and picture of the operator captured by the voice and picture capturing unit into the contents held by the contents holding unit; and
a recording unit operable to record the contents integrated by the contents integration unit on a recording medium.

19. A recording medium on which a video stream is recorded by an original video creating system,
wherein the original video creating system includes:
a video stream memorizing unit operable to memorize the video stream in advance;
a voice and picture capturing unit to capture at least one of a voice and a picture of an operator;
a combining unit operable to combine the video stream memorized in the video stream memorizing unit with at least one of the voice and the picture captured by the voice and picture capturing unit; and
